(19) United States
(12) Patent Application Publication
(10) Pub. No.: US 2024/0012193 A1
(43) Pub. Date: Jan. 11, 2024

(54) MULTI-LAYER LENS FOR VIRTUAL REALITY OPTICS

(71) Applicant: META PLATFORMS, INC., Menlo Park, CA (US)

(72) Inventors: Christopher Jack Brown, Deming, WA (US); Kurt Jenkins, Sammamish, WA (US)

(21) Appl. No.: 18/120,076

(22) Filed: Mar. 10, 2023

Related U.S. Application Data
(60) Provisional application No. 63/388,225, filed on Jul. 11, 2022.

(51) Int. Cl. F21V 8/00; G02B 27/01; B29D 11/00

(52) U.S. Cl. CPC G02B 6/0065; G02B 27/0172; B29D 11/00009; G02B 2027/0178

(57) ABSTRACT

Methods, systems, and apparatuses for creating or using a multi-layer lens. The processor may create a first layer lens, cool the first layer lens, and combine the first layer lens with a second layer lens to create a multi-layer lens.

### CROSS-REFERENCE TO RELATED APPLICATIONS

This application claims the benefit of U.S. Provisional Patent Application No. 63/388,225, filed on Jul. 11, 2022, entitled “MULTI-LAYER LENS FOR VIRTUAL REALITY OPTICS,” the contents of which are hereby incorporated by reference herein.

### TECHNOLOGICAL FIELD

This disclosure relates generally to methods, apparatuses, or computer program products for creating or using multi-layered lenses for virtual reality or augmented reality.

### BACKGROUND

Artificial reality (AR) is a form of reality that has been adjusted in some manner before presentation to a user, which may include, for example, a virtual reality, an augmented reality, a mixed reality, a hybrid reality, or some combination or derivative thereof. Artificial reality content may include completely computer-generated content or computer-generated content combined with captured (e.g., real-world) content. The artificial reality content may include video, audio, haptic feedback, or some combination thereof, any of which may be presented in a single channel or in multiple channels (such as stereo video that produces a three-dimensional (3D) effect to the viewer). Additionally, in some instances, artificial reality may also be associated with applications, products, accessories, services, or some combination thereof, that are used to create content in an artificial reality or are otherwise used (e.g., perform activities) in an artificial reality. Head-mounted displays (HMOs) may often be used to present visual content to a user for use in artificial reality applications. HMDs may include one or more near-eye displays with one or more lenses.

### SUMMARY

Disclosed herein are methods, apparatuses, or systems for creating or using a multi-layer lens. In an example, a device may include memory and a processor communicatively connected with the memory. The processor may effectuate operations that include transmitting instructions to create a first layer lens at a first position; detecting a cooling of the first layer lens to a threshold temperature; sending instructions to move the first layer lens to a second position; and transmitting instructions to combine the first layer lens with a second layer lens to create a single lens. The combining may be based on creating a second layer lens on top of the first layer lens or on bottom of the first layer lens.

In an example, a method may include casting a first layer lens; detecting the first layer lens is at a threshold stress level; based on the first layer lens being detected at the threshold stress level, injection molding a second layer lens on the first layer lens; and creating a multi-layer lens by combining the first layer lens and the second layer lens. The injection molding may include creating a flange incorporated into the second layer lens of the multi-layer lens.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### DESCRIPTION OF THE DRAWINGS

FIG. 1 illustrates an example head-mounted display (HMD) associated with artificial reality content.

FIG. 2 illustrates exemplary lens layers.

FIG. 3 illustrates an exemplary system that may be implemented for multi-layer lens for virtual reality optics.

FIG. 4 illustrates an exemplary method for multi-layer lens for virtual reality optics.

FIG. 5 illustrates an exemplary method for multi-layer lens for virtual reality optics.

FIG. 6 illustrates an exemplary block diagram of a device.

The figures depict various examples for purposes of illustration only. One skilled in the art will readily recognize from the following discussion that alternative examples of the structures and methods illustrated herein may be employed without departing from the principles described herein.

### DETAILED DESCRIPTION

Some examples are described hereinafter with reference to the accompanying drawings, in which some, but not all examples are shown. The disclosed subject matter be embodied in many different forms and should not be construed as limited to the examples set forth herein. Like reference numerals refer to like elements throughout.

It is to be understood that the methods and systems described herein are not limited to specific methods, specific components, or to particular implementations. It is also to be understood that the terminology used herein is for the purpose of describing particular examples only and is not intended to be limiting.

Conventionally, viewing lenses for AR products (e.g., virtual reality and augmented reality products) are manufactured as a single solid part and are mostly plastic lenses that are injection molded. These are conventionally thick lenses that require extended cycle times for cooling thick sections. These thick sections also may have high shrinkage factors, warping, or other movement, and may make it difficult to maintain an intended form of the lens, unless high pressure and or other measures are used. Disclosed herein are methods, systems, or apparatuses for a multi-layer lens approach that may allow a plurality of lenses (e.g., two, three, or more layers) to be molded into a single lens, which may be used for AR products.

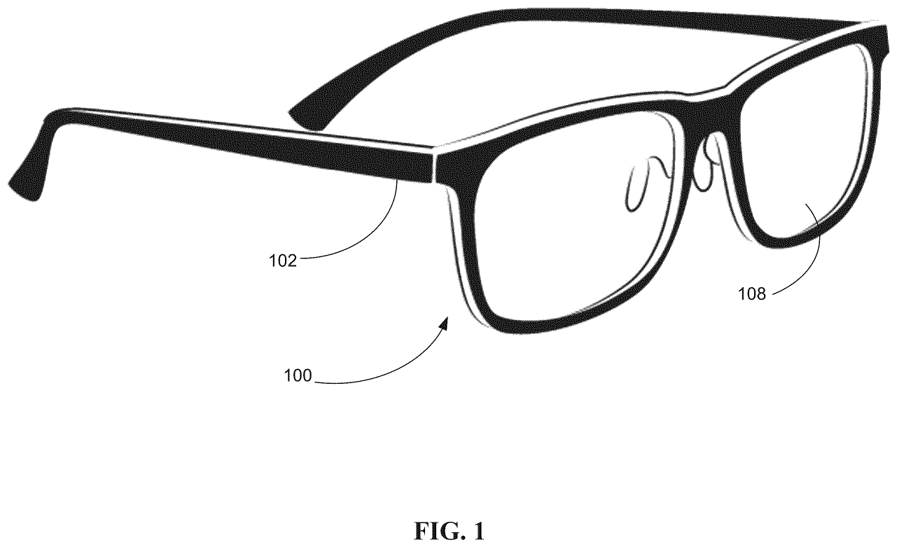

HMD's, including one or more near-eye displays, may often be used to present visual content to a user for use in artificial reality applications. One type of near-eye display may include an enclosure that houses components of the display or is configured to rest on the face of a user, such as for example a frame as shown in FIG. 1. The near-eye display may include a waveguide 108 that directs light from a projector to a location in front of the user's eyes.

FIG. 1 illustrates an example head-mounted display (HMD) 100 associated with artificial reality content. HMD 100 may be used for different applications, such as the metaverse. The metaverse may be considered an immersive virtual world that is facilitated by the use of virtual reality or augmented reality headsets, such as HMD 100. HMD 100 may include enclosure 102 (e.g., an eyeglass frame) or wave guide 108 (also referred herein as lens 108). Lens 108 may include one or more lenses that may be configured to direct images to a user's eye. In some examples, HMD 100 may be implemented in the form of augmented-reality glasses. Accordingly, lens 108 may be at least partially transparent to visible light to allow the user to view a real-world environment through lens 108. As disclosed in more detail herein, lens 108 may be formed based on a combination of a plurality of lenses (e.g., two, three, or more layers).

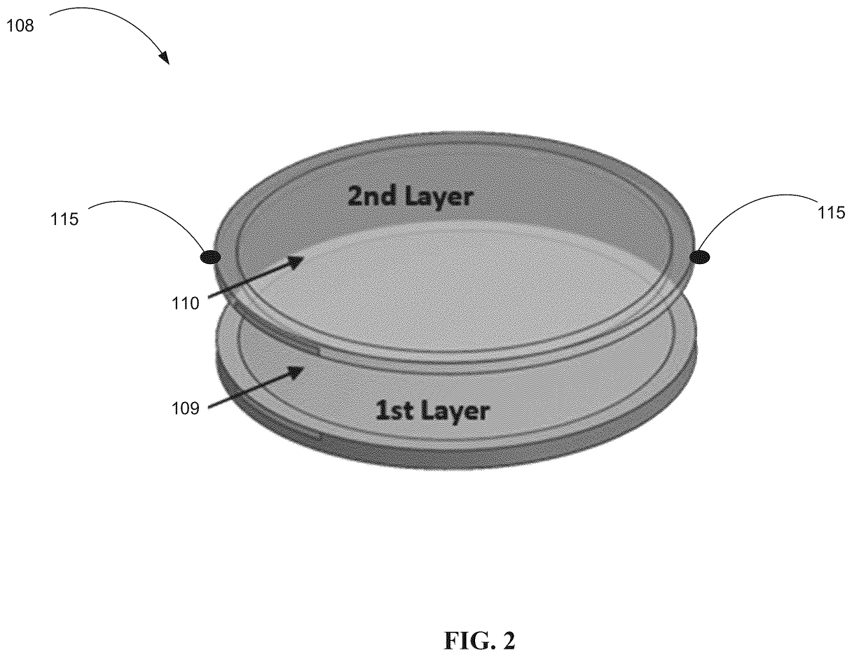

FIG. 2 illustrates an example lens. Lens 108 may include a plurality of lenses (e.g., multiple layers), such as lens 109 (e.g., a first layer) or lens 110 (e.g., a second layer). Lens 110 may include flanges 115. Flanges 115 may be used for mounting lens 108 to enclosure 102. There may be a shrink factor associated with a material used to make each lens. For example, nylon, polycarbonate, or polypropylene may all shrink when formed into a lens, but in different ways. So, molds, for example, may be oversized to take the shrink factor into account. The thicker the part (e.g., lens 109) the more significant the shrinkage factor becomes.

For a thick-walled component (e.g., seven millimeters or more which is based on material type), there is a likelihood that the size of such a thick section may be unpredictable, unless high pressure and costly equipment is used. The disclosed subject matter for creating a multi-layer lens may provide for a relatively low-cost process for creating a lens and a more predictably precise shape of the lens created or refined by casting, molding, machining, or the like.

Low internal stress in a part and high precision form accuracy should be considered in order to optimize performance of an optical system (e.g., pancake lenses). The disclosed multi-layer lens method, system, or apparatus may allow for such low internal stress and high precision accuracy.

As disclosed, lens 109 may be considered a preform or base part, which may be created in bulk. Lens 109 may be significantly thicker than lenses of other layers. Lens 109 may be the thickest in approximately the center section of the AR lens. This initial layer may be formed with less stress than conventional lenses. Lens 110, the second layer lens, may fill in any irregularity in the form of lens 109. The second layer lens may be a thin skin combined with lens 109 to bring lens 108 into the appropriate shape. Therefore, the finishing of the lens 108 which may happen based on the application of a second layer (e.g., lens 110) or third layer or more layers when needed (not shown). The disclosed subject matter allows lens 108 to be created at a much higher precision. There may be minimal or imperceptible shrinkage of a second or more layer due to the reduced amount of material and therefore the final shape of lens 108 may be controlled more precisely.

The disclosed subject matter allows for a process that does not use the conventional high pressures and causes less stress on lens 108, therefore minimizing retardation or birefringence. Further, the disclosed multi-layer lens increases the possible cavitation from a convention of four or less to at least double (e.g., eight or more), which may significantly reduce cost relative to conventional systems. Utilizing a multi-layer lens approach may permit for a higher cavitation and faster cycle time on the first layer. This first layer becomes less critical and more achievable to make. For the second layer or more layers, higher cavitation can be achieved because a much thinner wall section that is being handled is managed appropriately. This thinner wall section may vary in dimensions and amount of material used and may be determined based on the material of the first layer, the material of the second layer, the thickness of the first layer, or the thickness of the second layer, among other things. Examples of the ratios between the thicker first layer and the second layer may include a first layer that may be approximately 60%-80% of the thickness of the total multi-layer lens, while the second layer (or more layers) may be approximately 20%-40% of the thickness of the total multi-layer lens, which may depend on lens geometry. In another example, the first layer may be approximately 90%-95% of the thickness of the total multi-layer lens, while the second layer (or more layers) may be approximately 5%-10% of the thickness of the total multi-layer lens, which may depend on lens geometry. Other examples are contemplated herein.

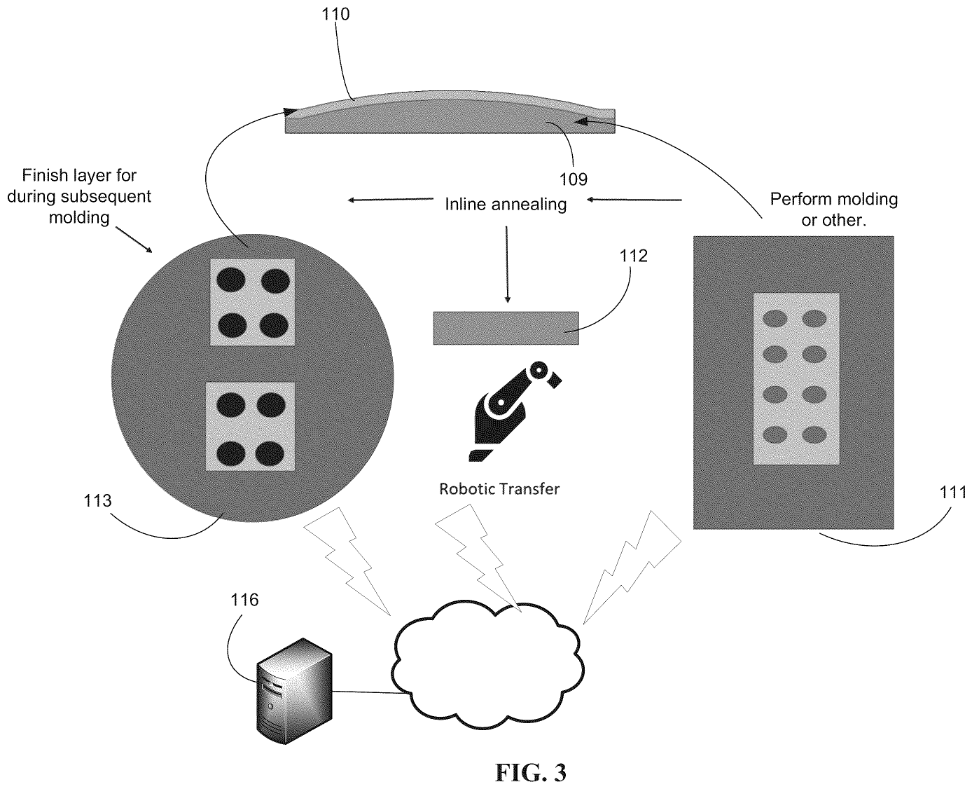

FIG. 3 illustrates a system for creating multi-layer lenses. There may be a location 111 in which molding, casting, fabricating, or the like may occur in order to create lens 109. At location 112, there may be a cooling or annealing station for the created lens 109. Lens 109 may be placed at location 113, and another layer (e.g., lens 110) may be appropriately added to lens 109. Devices at location 111, location 112, or location 113 may be communicatively connected with each other or server 116. Server 116 may send instructions to devices (e.g., electronic heating devices, electronic cooling devices, conveyor belts, robotic equipment, manufacturing equipment, or other devices).

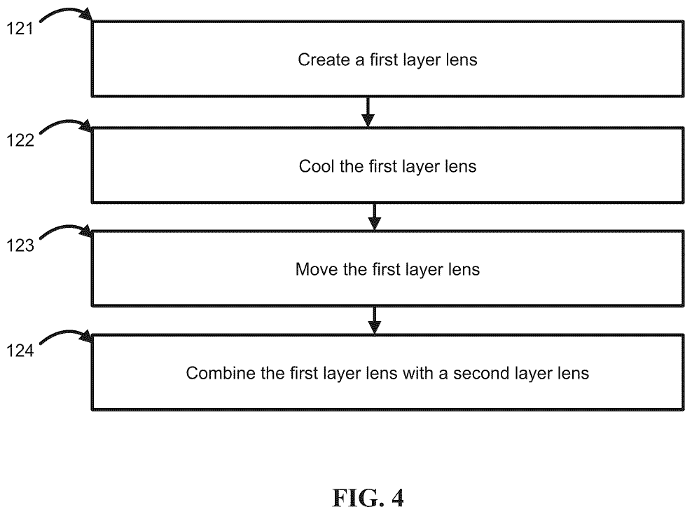

FIG. 4 illustrates an exemplary method for multi-layers lenses. At block 121, a first lens (e.g., lens 109) is created. The lens 109 may be made using a mold, cast, or fabrication process at location 111. Lens 109 may be made from a single injection mold or multi-cavity injection mold. The lens 109 may be a base or bottom layer that is within a threshold thickness, in which lens 109 may cool within a threshold period or lens 109 shrinks a threshold amount during the threshold period.

At block 122, subsequent to block 121, lens 109 may be placed in a cooling or annealing station (e.g., location 112) that may accommodate one or more lenses. Annealing may be considered a process of slowly cooling hot glass objects after they have been formed, to relieve residual internal stresses introduced during manufacture. Therefore, block 123 may be executed when there is an indication received that a threshold level of stress is met (e.g., stress may be associated with or based on time, temperature, weight, volume or other measurement of lens material, lens material type, or lens material thickness). The annealing or cooling may be inline, such as on a conveyor belt, a carousel, or a stationary cooling fixture.

At block 123, lens 109 may be moved from location 112 to location 113 using a robotic arm or other machinery. Location 113 may be another mold, cast, or printer where the next layer or layers will be created.

At block 124, a second layer lens (e.g., lens 110) may be created on lens 109 in order to create lens 108. Lens 110 may be placed on the top of lens 109, on the bottom of lens 109, or otherwise form around lens 109. Lens 110 may be created by injection molding, casting, or the like.

One or more flanges 115 may be created with lens 110 (e.g., molded with lens 110). Flange 115 may be a geometric feature (e.g., protruded rim, ridge, bump, or the like) of lens 110 that may be used to mount lens 108 to enclosure 102 of HMD 100 or the like. Mounting and positioning the lenses may affect the functionality of HMD 100. The disclosed system may allow for increased datum accuracy based on minimal material shrinkage in a second layer or subsequent layers. The accuracy of the datum structure for mounting or shape or position of flange 115 may be directly related to the thickness of the layer (e.g., lens 110) in which flange 115 is formed from. The position of flange 115 for mounting may be based on the datum. Based on this process, flanges 115 may be more precisely and consistently positioned for their intended purpose. Flange 115 is a feature that may be more accurately molded on a layer that results in a locating feature that may then be located accurately to the overall assembly HMD 100 or enclosure 102.

In addition, or alternative to, creation of flange 115, there may be in-mold lamination (IML) of lens 110 (or other lenses at other layers). Lenses may incorporate additional optical films that are glued on top of the lens to make the lens have a desired effect, such as 3D lens effect or transparent hologram effect. It is contemplated herein that a film that has a filter (e.g., desired effect) may be loaded into an injection molding tool and into lens 110 (instead of glued) during the disclosed process, which allows for minimal adhesive or adhesive-free lamination. Lamination that is not accurate may create different artifacts, such as orange tinges or undesirable refractive indexes that may cause scatter or loss of light.

Possible materials for one or more of the layers may be plastic, glass, or clear coatings, among other things. It is contemplated herein that the layers may be created by different processes. For example, lens 109 may be created using casting which may be done at a lower cost than injection molding when material, time, or the like are considered. Injection molding (or another process) may be selected for the second layer (or final layer) in order to create lens 110 (which may include associated flange 115) with a threshold level of precision which may allow for more consistent creation of flanges and lenses for their intended purpose.

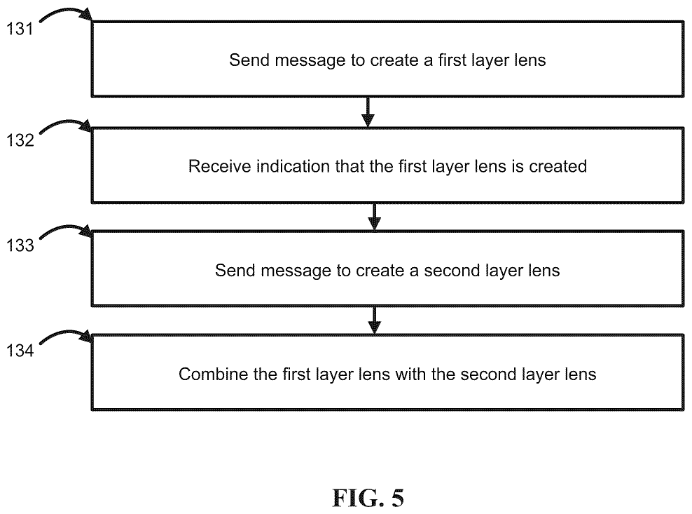

FIG. 5 illustrates an exemplary method for multi-layers lenses. At block 131, send a message to create a first layer lens (e.g., lens 109) at a first position (e.g., position 111).

At block 132, receive an indication that the first layer lens (e.g., lens 109) is created.

At block 133, in response to receiving the indication that the first layer lens (e.g., lens 109) is created or threshold level reached (e.g., time or temperature), providing instructions to create a second layer lens (e.g., lens 110). Lens 110 may include flange 115 or lamination. Lamination may be incorporated by using an in-mold lamination process or glue. It is contemplated that flange 115 or lamination may occur at a plurality of indicated layers or only at one layer, such as an indicated final layer (e.g., lens 110) for creating lens 108.

At block 134, combining the first layer lens (e.g., lens 109) to create a single lens (e.g., lens 108), the combining based on: creating a second layer lens (e.g., lens 110) on top of the first layer lens (e.g., lens 109), on bottom of the first layer lens (e.g., lens 109), or otherwise forming around the first layer lens to fill gaps or imperfections.

The multi-layer approach disclosed herein may allow the plurality of lenses to be molded in a series of shorter cycle times and may reduce the overall cycle times of conventional methods by greater than 40%. Additionally managing the shrinkage and retardation (or birefringence) of thinner wall sections may allow for parts to maintain better shape (form error) and lower stress.

The disclosed subject matter may include an approach for manufacturing multi-layer lenses that may allow a plurality of layers (e.g., two, three, or more layers) to be molded into a single lens. This may allow for the use of less energy during manufacturing and more accurately shaped lenses and flanges (e.g., mounts). Flanges 115 may be used to attach the lenses to the frame of HMD 100. The disclosed subject matter may allow for the integration of lamination and magnification effects to the lenses in a multi-layer lens process.

The disclosed subject matter provides the opportunity to make different types of lens-mounting architecture. These types of mounting features may be created later in the lens manufacturing process.

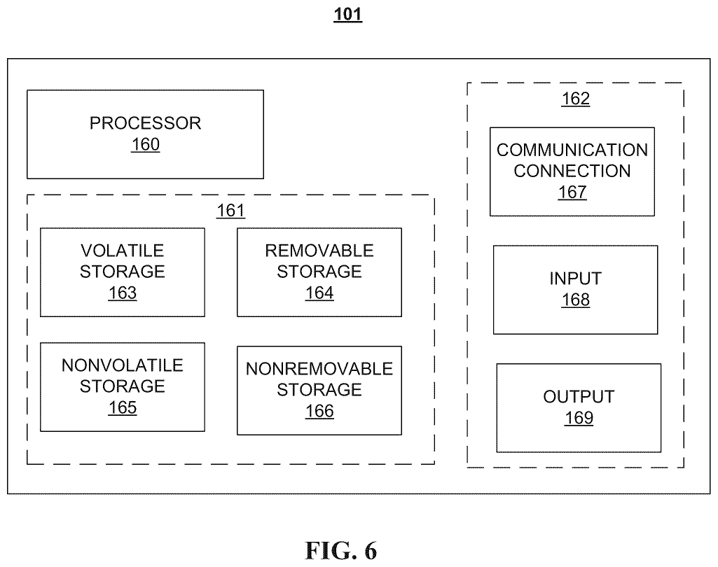

FIG. 6 is an exemplary block diagram of a device, such as HMD 100, server 116, or another device. In an example, server 116 may include hardware or a combination of hardware and software. The functionality to facilitate telecommunications via a telecommunications network may reside in one or combination of devices. A device may represent or perform functionality of one or more devices, such as a component or various components of a cellular broadcast system wireless network, a processor, a server, a gateway, a node, a gaming device, or the like, or any appropriate combination thereof. It is emphasized that the block diagram depicted in FIG. 6 is exemplary and not intended to imply a limitation to a specific implementation or configuration. Thus, server 116, for example, may be implemented in a single device or multiple devices (e.g., single server or multiple servers, single gateway or multiple gateways, single controller or multiple controllers). Multiple network entities may be distributed or centrally located. Multiple network entities may communicate wirelessly, via hardwire, or any appropriate combination thereof.

Server 116 or another device may comprise a processor 160 or a memory 161, in which the memory may be coupled with processor 160. Memory 161 may contain executable instructions that, when executed by processor 160, cause processor 160 to effectuate operations associated with creating multi-layer lenses, or other subject matter disclosed herein.

In addition to processor 160 and memory 161, server 116 or another device may include an input/output system 162. Processor 160, memory 161, or input/output system 162 may be coupled together (coupling not shown in FIG. 6) to allow communications between them. Each portion of server 116 or another device may include circuitry for performing functions associated with each respective portion. Thus, each portion may include hardware, or a combination of hardware and software. Input/output system 162 may be capable of receiving or providing information from or to a communications device or other network entities configured for telecommunications. For example, input/output system 162 may include a wireless communications (e.g., Wi-Fi, Bluetooth, or 5G) card. Input/output system 162 may be capable of receiving or sending video information, audio information, control information, image information, data, or any combination thereof. Input/output system 162 may be capable of transferring information with server 116 or another device. In various configurations, input/output system 162 may receive or provide information via any appropriate means, such as, for example, optical means (e.g., infrared), electromagnetic means (e.g., radio frequency (RF), Wi-Fi, Bluetooth), acoustic means (e.g., speaker, microphone, ultrasonic receiver, ultrasonic transmitter), or a combination thereof. In an example configuration, input/output system 162 may comprise a Wi-Fi finder, a two-way GPS chipset or equivalent, or the like, or a combination thereof.

Input/output system 162 of server 116 or another device also may include a communication connection 167 that allows server 116 or another device to communicate with other devices, network entities, or the like. Communication connection 167 may comprise communication media. Communication media typically embody computer-readable instructions, data structures, program modules or other data in a modulated data signal such as a carrier wave or other transport mechanism and includes any information delivery media. By way of example, and not limitation, communication media may include wired media such as a wired network or direct-wired connection, or wireless media such as acoustic, RF, infrared, or other wireless media. The term computer-readable media as used herein includes both storage media and communication media. Input/output system 162 also may include an input device 168 such as keyboard, mouse, pen, voice input device, or touch input device. Input/output system 162 may also include an output device 169, such as a display, speakers, or a printer.

Processor 160 may be capable of performing functions associated with telecommunications, such as functions for processing broadcast messages, as described herein. For example, processor 160 may be capable of, in conjunction with any other portion of server 116 or another device, determining a type of broadcast message and acting according to the broadcast message type or content, as described herein.

Memory 161 of server 116 or another device may comprise a storage medium having a concrete, tangible, physical structure. As is known, a signal does not have a concrete, tangible, physical structure. Memory 161, as well as any computer-readable storage medium described herein, is not to be construed as a signal. Memory 161, as well as any computer-readable storage medium described herein, is not to be construed as a transient signal. Memory 161, as well as any computer-readable storage medium described herein, is not to be construed as a propagating signal. Memory 161, as well as any computer-readable storage medium described herein, is to be construed as an article of manufacture.

Herein, a computer-readable storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable storage medium may be volatile, non-volatile, or a combination of volatile and non-volatile, where appropriate.

While the disclosed systems have been described in connection with the various examples of the various figures, it is to be understood that other similar implementations may be used or modifications and additions may be made to the described examples of creating multi-layer lenses, among other things as disclosed herein. For example, one skilled in the art will recognize that creating multi-layer lenses, among other things as disclosed herein in the instant application may apply to any environment, whether wired or wireless, and may be applied to any number of such devices connected via a communications network and interacting across the network. Therefore, the disclosed systems as described herein should not be limited to any single example, but rather should be construed in breadth and scope in accordance with the appended claims.

In describing preferred methods, systems, or apparatuses of the subject matter of the present disclosure—creating multi-layer lenses—as illustrated in the Figures, specific terminology is employed for the sake of clarity. The claimed subject matter, however, is not intended to be limited to the specific terminology so selected.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another example includes from the one particular value or to the other particular value. Similarly, when values are expressed as approximations, by use of the antecedent “about,” it will be understood that the particular value forms another example. All ranges are inclusive and combinable. It is to be understood that the terminology used herein is for the purpose of describing particular aspects only and is not intended to be limiting.

This written description uses examples to enable any person skilled in the art to practice the claimed subject matter, including making and using any devices or systems and performing any incorporated methods. Other variations of the examples are contemplated herein (e.g., skipping steps, combining steps, or adding steps between exemplary methods disclosed herein). It is to be appreciated that certain features of the disclosed subject matter which are, for clarity, described herein in the context of separate examples, may also be provided in combination in a single example. Conversely, various features of the disclosed subject matter that are, for brevity, described in the context of a single example, may also be provided separately or in any sub-combination. Further, any reference to values stated in ranges includes each and every value within that range. Any documents cited herein are incorporated herein by reference in their entireties for any and all purposes. Although artificial reality systems are used in examples herein, it is contemplated that the disclosed methods, systems, or apparatuses may be applicable in other scenarios.

The scope of this disclosure encompasses all changes, substitutions, variations, alterations, and modifications to the examples described or illustrated herein that a person having ordinary skill in the art would comprehend. The scope of this disclosure is not limited to the examples described or illustrated herein. Moreover, although this disclosure describes and illustrates respective examples herein as including particular components, elements, feature, functions, operations, or steps, any of these examples may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular examples as providing particular advantages, particular examples may provide none, some, or all of these advantages.

Methods, systems, and apparatuses, among other things, as described herein may provide for creating multi-layer lenses. A method, system, computer readable storage medium, or apparatus may provide for communicating instructions to create a first layer lens, the first layer lens created a first position; receiving an indication that the first layer lens is created; in response to receiving the indication that the first layer lens is created, communicating instructions to create a second layer lens; and communicating instructions to combine the first layer lens and the second layer lens to create a single lens (e.g., a single multi-layer lens). The indication that the first layer lens may be created may include an indication that the first layer lens has reached a temperature within a temperature threshold. The instructions may be to combine the first layer lens and the second layer lens to create a single lens comprises an indication to create the second layer lens using injection molding or casting on top of or on the bottom of the first layer lens. The single lens may be used in a head-mounted display. All combinations in this and the below paragraphs (including the removal or addition of steps) are contemplated in a manner that is consistent with the other portions of the detailed description.

A method may include creating a first layer lens at a first position; cooling the first layer lens; and moving the first layer lens to a second position. The first layer lens may be done without compression. The combining of the first layer lens may be to create a single lens. The combining may be based on: creating a second layer lens on top of the first layer lens or on bottom of the first layer lens. A single lens for a head-mounted display may include a plurality of lenses, such as a first layer lens; a second layer lens; and a third layer lens. The first layer lens, second layer lens, or the third layer lens may be created by using injection molding or casting. The first layer lens, second layer lens, or the third layer lens may be refined using machining. The first layer lens, second layer lens, or the third layer lens may include one or more flanges or may include lamination. All combinations in this paragraph (including the removal or addition of steps) are contemplated in a manner that is consistent with the other portions of the detailed description.

A multi-layer lens used for augmented reality application, wherein the multi-layer lens is produced by: creating a first layer lens; cooling the first layer lens; creating a final layer lens with one or more flanges; and combining the final layer lens with first layer lens to create the multi-layer lens. The final layer lens with the one or more flanges may include in-mold lamination. The final layer lens may be a second, third, or more layer lens. The intermediate lenses may or may not include flanges or lamination (in-mold or glued). The first layer lens may include polycarbonate or the second layer lens may include polypropylene. All combinations in this paragraph and the above paragraphs (including the removal or addition of steps) are contemplated in a manner that is consistent with the other portions of the detailed description.

A method may include casting a first layer lens; detecting the first layer lens is at a threshold stress level; based on the first layer lens detected at the threshold stress level, injection molding a second layer lens on the first layer lens; and creating a multi-layer lens by combining the first layer lens and the second layer lens. The injection molding may include creating a flange incorporated into the second layer lens of the multi-layer lens. The injection molding may include incorporating lamination via in-mold lamination or another process into the second layer lens of the multi-layer lens. The threshold stress level may be based on a threshold temperature, a threshold time, or a threshold volume (or other measurement) of the first layer lens. The threshold stress level may be determined based on material type of the first layer lens, diameter, volume, or other measurement of the first layer lens. All combinations in this paragraph and the above paragraphs (including the removal or addition of steps) are contemplated in a manner that is consistent with the other portions of the detailed description.

A system may effectuate operations that include providing instructions to create a first layer lens, the first layer lens created at a first position; receiving an indication that the first layer lens is at a threshold stress level; in response to receiving the indication that the first layer lens is at a threshold stress level, providing instructions to create a second layer lens; and providing instructions to combine the first layer lens and the second layer lens to create a multi-layer lens. The second layer lens comprises a lamination with a field effect associated with artificial reality, such as a 3D effect. All combinations in this paragraph and the above paragraphs (including the removal or addition of steps) are contemplated in a manner that is consistent with the other portions of the detailed description.

What is claimed:

1. A method comprising:
casting a first layer lens;
detecting the first layer lens is at a threshold stress level;
based on the first layer lens detected at the threshold stress level, injection molding a second layer lens on the first layer lens; and
creating a multi-layer lens by combining the first layer lens and the second layer lens.

2. The method of claim 1, wherein the injection molding comprises creating a flange incorporated into the second layer lens of the multi-layer lens.

3. The method of claim 1, wherein the injection molding comprises incorporating lamination via in-mold lamination into the second layer lens of the multi-layer lens.

4. The method of claim 1, wherein the threshold stress level is based on a threshold temperature.

5. The method of claim 1, wherein the threshold stress level is based on a threshold time.

6. The method of claim 1, wherein the threshold stress level is determined based on material type of the first layer lens.

7. The method of claim 1, wherein the threshold stress level is determined based on a diameter or volume of the first layer lens.

8. The method of claim 1, further comprising inserting the multi-layer lens into a head-mounted display.

9. A system comprising:
one or more processors; and
memory coupled with the one or more processors, the memory storing executable instructions that when executed by the one or more processors cause the one or more processors to effectuate operations comprising:
providing instructions to create a first layer lens, the first layer lens created at a first position;
receiving an indication that the first layer lens is at a threshold stress level;
in response to receiving the indication that the first layer lens is at the threshold stress level, providing instructions to create a second layer lens; and
providing instructions to combine the first layer lens and the second layer lens to create a multi-layer lens.

10. The system of claim 9, wherein the indication that the first layer lens is at the threshold stress level comprises an indication that the first layer lens has reached a temperature within a temperature threshold.

11. The system of claim 9, wherein the instructions to combine the first layer lens and the second layer lens to create the multi-layer lens comprises an indication to create the second layer lens using injection molding or casting on or about the first layer lens.

12. The system of claim 9, wherein the second layer lens comprises a lamination with a field effect associated with artificial reality.

13. The system of claim 9, wherein the second layer lens comprises a flange incorporated during the creation of the second layer lens.

14. A multi-layer lens used for augmented reality application, wherein the multi-layer lens is produced by:
creating a first layer lens;
cooling the first layer lens to a threshold temperature;
creating a second layer lens with one or more flanges; and
combining the second layer lens with first layer lens to create the multi-layer lens.

15. The multi-layer lens of claim 14, wherein the second layer lens with the one or more flanges comprises in-mold lamination.

16. The multi-layer lens of claim 14, wherein the second layer lens with the one or more flanges comprises glued lamination.

17. The multi-layer lens of claim 14, wherein the second layer lens is refined using machining.

18. The multi-layer lens of claim 14, wherein the second layer lens is created using injection molding.

19. The multi-layer lens of claim 14, wherein the first layer lens is created using casting.

20. The multi-layer lens of claim 14, wherein the first layer lens comprises polycarbonate.
